(19) United States
(12) Patent Application Publication
(10) Pub. No.: US 2006/0256569 A1
(43) Pub. Date: Nov. 16, 2006

(54) Secure bulb assembly

(76) Inventor: Wun-Fang Pan, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/125,228

(22) Filed: May 10, 2005

(51) Int. Cl. F21V 17/06

(52) U.S. Cl. 362/437

(57) ABSTRACT

The invention relates to a secure bulb assembly of a light string, which includes a control bulb assembly and several regular bulb assemblies. The bulb with the holder must be connected with a corrective shell in order to obtain the electrical connection. When a mistaken connection occurs, there will be no electrical connection between the bulb assemblies. Hence, the light string will be secure and utilized.

### FIELD OF THE INVENTION

The present invention relates to a secure bulb assembly of a light string, wherein the bulb must be connected with a relating corrective shell in order to allow an electrical connection for lighten the bulb.

### BACKGROUND OF THE INVENTION

A known light string includes a control bulb assembly and many regular bulb assemblies, wherein the control bulb can control the regular bulbs to twinkle at a preset cycle. It is the most important to put the control bulb into the control shell for obtaining the bulbs being lightened as desired. There are some structures to reach this purpose. Such as in U.S. Pat. No. 6,474,841, it includes the control shell having different size from the regular shell while the control bulb with its holder has different size from the regular bulb with the holder. Hence, a smaller regular shell cannot receive the larger control bulb with the holder that prevents from a mistaken connection. The U.S. Pat. No. 6,806,656 shows another structure, which includes different sizes or shapes of the control bulb assembly and the regular bulb assemblies. And the control bulb with the holder can and only can be received in the control shell, and so does a regular one.

Please refer to FIGS. 1 and 2, another traditional design is shown, wherein a control bulb (1) is received in a control holder (2), and then received in a control shell (3). The control holder (2) has a side projection (21) and the control shell (3) has an inner groove (31). So the control holder (2) with the control bulb (1) can just received in the control shell (3) as the projection (21) is engaged within the groove (31). Therefore, the control holder (2) with the control bulb (1) cannot be received in a regular shell (3′). But in this embodiment, a regular holder (2′) with a regular bulb (1′) can still be received in a control shell (3) that becomes a drawback and danger.

### SUMMARY OF THE INVENTION

The present invention is to provide a secure bulb assembly of a light string, wherein the control bulb and the regular bulb can be received in the control or regular shell alternatively without conductive danger. Any mistaken connection between the bulb assemblies will not be electrically connection at all. Now, accompanying with the following drawings, the character of the present invention will be described here and after.

### BRIEF DESCRIPTION OF THE DRAWINGS

FIG. 1 is an exploded perspective view showing a conventional control bulb and a control shell.

FIG. 2 is an exploded perspective view showing a conventional regular bulb and a regular shell.

FIG. 3 is an exploded perspective view of a control bulb and a control shell according to the present invention.

FIG. 4 is an assembled view of FIG. 3.

FIG. 5 is a cross-sectional plan view of FIG. 3.

FIG. 6 is a cross-sectional plan view of FIG. 4.

FIG. 7 is an exploded perspective view of a regular bulb and a regular shell according to the present invention.

FIG. 8 is an assembled view of FIG. 7.

FIG. 9 is an exploded perspective view of a control bulb and a regular shell according to the present invention.

FIG. 10 is an assembled view of FIG. 9.

FIG. 11 is a cross-sectional plan view of FIG. 9.

FIG. 12 is a cross-sectional plan view of FIG. 10.

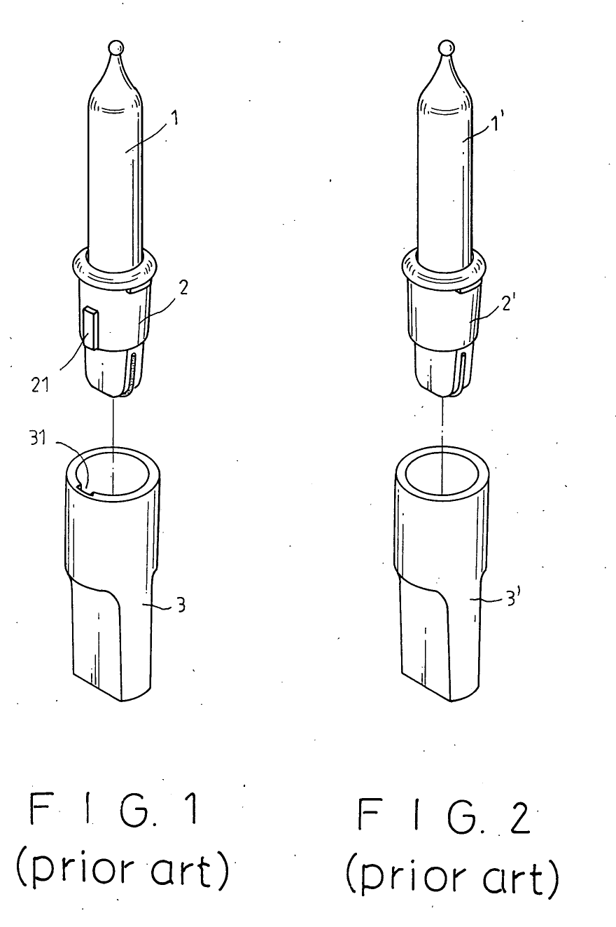

### DETAILED DESCRIPTION OF THE PREFERRED EMBODIMENT

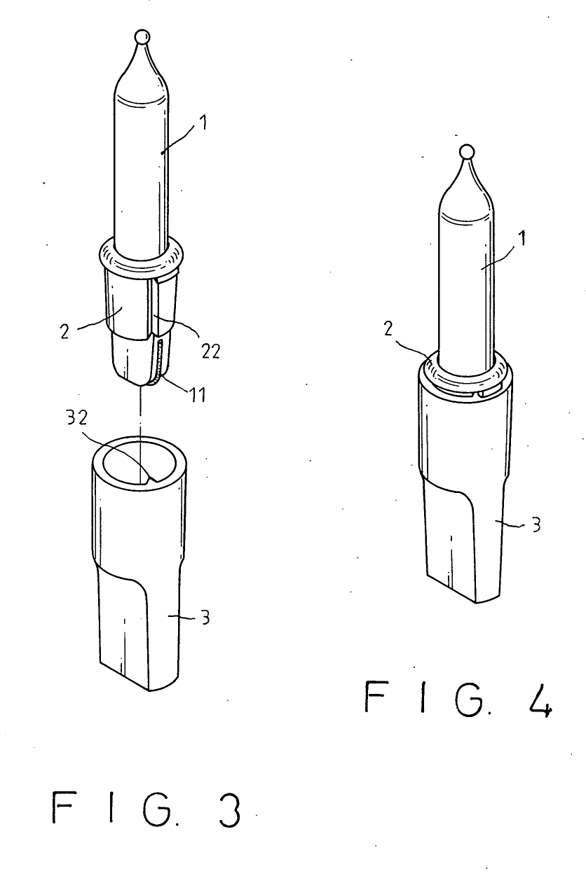

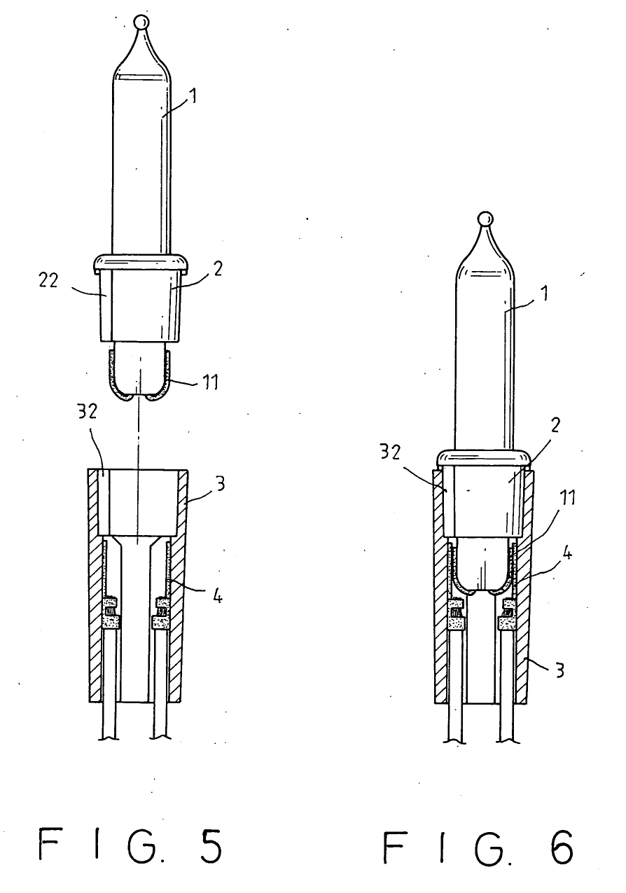

Please refer to FIG. 3 to 6 firstly, the present invention relates to an improved secure bulb assembly of a light string, which includes a control bulb (1), a control holder (2), and a control shell (3). The control holder (2) has a side groove (22) at a relating position to a conductive wire (11) of the control bulb (1). The control shell (3) has a projection (32) at a relating position to the groove (22) of the control holder (2). Hence, when the control bulb (1) with the control holder (2) is received in the control shell (3), the projection (32) must be engaged with the groove (22) and the conductive wire (11) of the bulb (1) is therefore contacting pins (4) in the shell (3) that obtains an electrical connection.

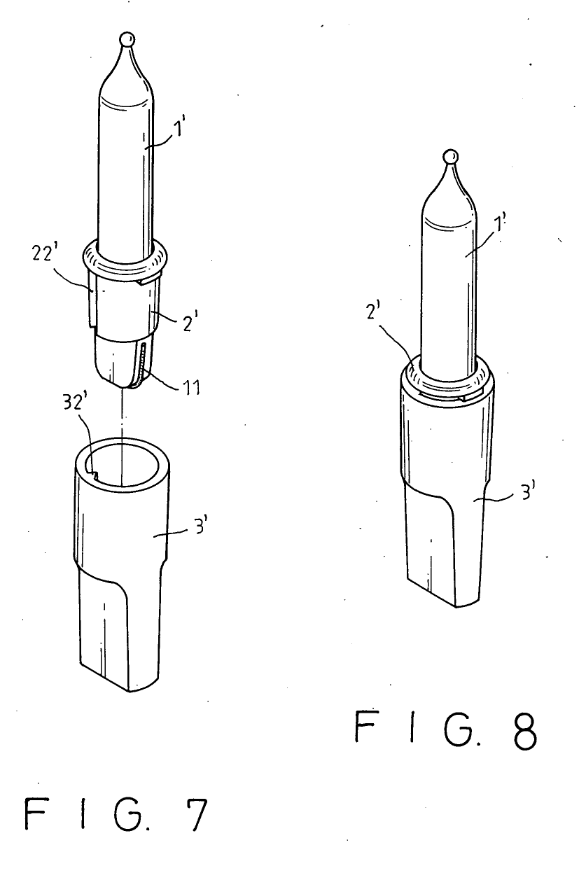

Please refer to FIGS. 7 and 8, it shows a regular bulb assembly of the present invention, wherein the regular holder (2′) has a side groove (22′), which has a different position relating to the conductive wire (11′) of the regular bulb (1′). The regular shell (3′) has an inward projection (32′) relating to the groove (22′). Under the above corrective connection, the electrical connection is then completed.

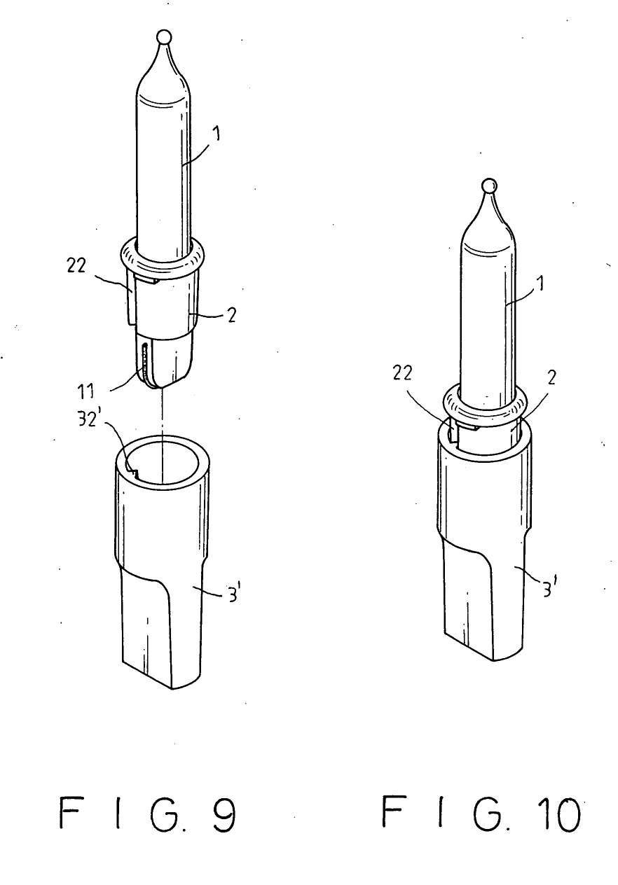

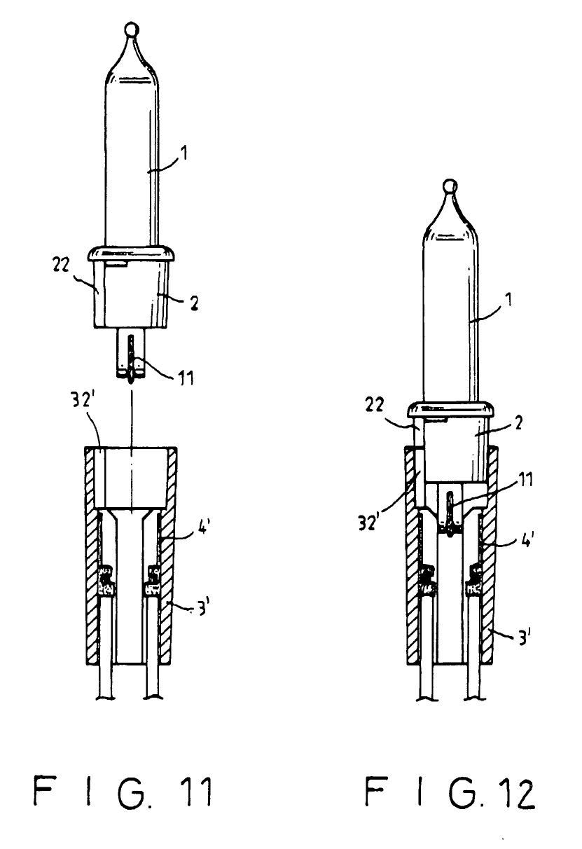

If there is a mistaken connection, such as shown in FIG. 9 to 12, a control bulb (1) with the control holder (2) is to be received in a regular shell (3′), it will be found that no electrical connection can be obtained. Since the projection (32′) of the regular shell (3′) must be aliened with the groove (22) of the control holder (2), the connection therebetween is then obtained. At this connection, the conductive wire (11) of the control bulb (1) will not contact the pins (4′) in the regular shell (3′) and the electrical contact will not be performed. It can be understood that when a regular bulb with a regular holder is received in a control shell, wherein there will not obtain any electrical connection. So it will be secure whenever any mistaken connection occurs.

Accordingly, the secure bulb assembly of the light string of the present invention is useful and invented. It is only an exemplary to illustrate our embodiment and is not to limit the scope of this application. Any modified embodiments with similar merit are also claimed according to the present invention.

I claim:

1. A secure bulb assembly of a light string including a control bulb assembly and several regular bulb assemblies, wherein the control bulb assembly includes a control bulb, a control holder, and a control shell, in which the control holder has a side groove at a position relating to a conductive wire of the control bulb, and the control shell has a projection relating to the position of the groove in order that the projection must be engaged with the groove when the control shell receives the control holder and the control bulb while the conductive wires contact the pins in the control shell; the regular bulb assembly including a regular bulb received in a regular holder and then received in a regular shell, wherein the regular holder has a side groove at a different position relating to the conductive wires of the regular bulb, and the regular shell has a projection at a position relating to the groove of the regular holder, in which the regular holder with the regular bulb received in the regular shell while the conductive wires of the regular bulb contact the pins in the regular shell for electrical connection.

2. The secure bulb assembly of a light string as claimed in claim 1, wherein a control bulb with a control holder can be received in a regular shell, and a regular bulb with a regular holder can be received in a control shell, but both of which obtain no electrical connection at all.
